(19) United States
(12) Patent Application Publication
(10) Pub. No.: US 2023/0182505 A1
(43) Pub. Date: Jun. 15, 2023

(54) HUB, IN PARTICULAR FOR BICYCLES, HAVING A FREE-WHEEL MECHANISM

(71) Applicant: Ingo Elsner, Dresden (DE)

(72) Inventors: Roman Elsner, Dresden (DE); Alfred Jyrch, Dresden (DE)

(21) Appl. No.: 18/063,990

(22) Filed: Dec. 9, 2022

(30) Foreign Application Priority Data
Dec. 10, 2021 (DE) 102021132705.9

(51) Int. Cl. B60B 27/04; B60B 27/02

(52) U.S. Cl. CPC B60B 27/047; B60B 27/023

(57) ABSTRACT

The invention relates to a hub, in particular for bicycles, comprising an axle on which a hub member and a free-wheel member are rotatably arranged, wherein the hub member and the free-wheel member are coupled to each other by a free-wheel mechanism which is based on a pairing of saw-tooth tooth arrangements, which are engaged with each other, of axially adjacent toothed discs and which thereby forms a rotationally secure connection for one rotation direction between the free-wheel member and the hub member, wherein at least two pairings of cooperating saw-tooth tooth arrangements are provided.

### CROSS-REFERENCE TO RELATED APPLICATION

This application claims priority under 37 CFR 1.55 to German patent application no. 10 2021 132 705.9 filed on Dec. 10, 2021, the contents of which are incorporated herein in its entirety.

### BACKGROUND AND FIELD

The invention relates to a hub, in particular for bicycles, having a free-wheel mechanism. Apart from bicycles, the hub may also be provided for other applications, for example, in all types of trailers, in particular bicycle trailers, in wheelchairs and the like.

Hubs of the type being discussed here are used to connect the fixed wheel axle to a rim which rotates about this axle and which carries a pneumatic tire. The connection between the hub and the rim is usually brought about by spokes which are made from steel, aluminium, carbon or other textiles and which are arranged in accordance with a predetermined pattern and retained at each of the ends thereof in a respective hole, provided for this purpose, of the hub and rim.

Particularly in wheels which are used in the sporting sector, and quite particularly in wheels for use in competitions, high demands are placed on the hub. On the one hand, the hub is intended to rotate with as little friction resistance as possible, on the other hand, it is intended to allow a substantially play-free support, become dirty and worn only to a small degree and be easy to assemble and disassemble.

Generally, the rear wheel is driven in a bicycle. To this end, a free-wheel member, on which an individual chain pinion or a so-called cartridge comprising a plurality of chain pinions is/are securely fitted is arranged beside the actual hub housing on the axle of the rear wheel hub in order to transmit the drive torque which is generated by the rider on the pedal cranks by means of a roller chain, a belt or a cardan shaft to the rear wheel.

So that the pedal cranks do not have to constantly also rotate, for example, during downhill travel or during a break from pedalling, the rear wheel hub of most bicycles has a free-wheel mechanism which transmits drive force of the driver or free-wheel member from the free-wheel member to the hub housing and consequently to the rear wheel, while during backward pedalling the free-wheel action causes the hub housing and the free-wheel member to be able to rotate relative to each other.

According to the current prior art, the torque transmission is carried out in free-wheel hubs with toothed disc free-wheel by means of two annular toothed discs and a coupling interface. In this case, the toothed discs each have at the mutually facing front faces thereof a saw-tooth tooth arrangement, which tooth arrangements mesh in each other during relative rotation in a rotation direction and thus allow the torque transmission as a result of a positive-locking connection while they slide against each other in the opposite rotation direction so that no torque is transmitted, but with the axial spacing of the two toothed discs becoming greater.

Alternative embodiments use a pairing of a toothed disc with a saw-tooth tooth arrangement and a perforated disc with holes, in which the saw teeth engage in a positive-locking manner in one rotation direction.

A saw-tooth tooth arrangement can in this case be planar or non-planar, it may have bevel, helical, spur or oblique teeth or be a hybrid.

The German Utility Model G 94 19 357.6 U1 describes a free-wheel hub for a bicycle having a wheel axle, on which a hub member is rotatably arranged and a free-wheel member is arranged in axial abutment therewith, wherein the hub member and the free-wheel member are coupled to each other via a free-wheel mechanism which forms a rotationally secure connection between the free-wheel member and the hub member only for one rotation direction, and wherein the free-wheel member is connected to the wheel axle via two ball bearings, wherein a releasable securing means with which the free-wheel member can be urged against the hub member is provided, and wherein the free-wheel member can be drawn away from the hub member in an axial direction without force being applied with the securing means being released.

DE 198 47 673 A1 discloses a hub, in particular for bicycles and the like, having a hub axle, a hub housing which is arranged concentrically relative to this hub axle, at least one bearing device which comprises at least two bearings and which is arranged between this hub axle and this hub housing so that this hub housing is rotatably supported in relation to this hub axle, a free-wheel member which is rotatably supported in relation to this hub axle and which is configured so that at least one toothed wheel is intended to be arranged on this free-wheel member, a free-wheel device which is arranged between this free-wheel member and this hub housing and which has two toothed discs, the tooth faces of which are pressed against each other by a pretensioning device, wherein these two toothed discs are concentrically arranged relative to this hub axle and are arranged in a plane perpendicular to an axle line of this hub axle in the case of approved assembly of this hub at least in the rest state, and wherein these toothed discs are retained in a floating manner so that tilting in relation to this plane perpendicular to this axle line of this hub axle is possible.

DE 10 2019 000 511 A1 discloses a bicycle hub having a release effect which is achieved during idle travel at the locking detent faces and in which the free-wheel function is also performed by a pairing of two asymmetrical saw-tooth tooth arrangements which allow a torque transmission in one rotation direction of a relative rotation, and which slide against each other in the other rotation direction of a relative rotation. One of these saw-tooth tooth arrangements is arranged at the front side of a first toothed disk which is connected to the hub housing in a rotationally secure manner and the other is arranged on a front face of an axially displaceable second toothed disc which is connected to the free-wheel member in a rotationally secure manner. At the other front face of the second toothed disc, a symmetrical groove tooth arrangement is arranged. This groove tooth arrangement again cooperates with an additional symmetrical groove tooth arrangement which is arranged at the front side of a so-called axially displaceable pressure disc which is arranged on the axle in a rotationally secure manner; wherein the tooth flanks of the two groove tooth arrangements slide against each other in both rotation directions of a relative rotation. Two resilient elements which act in opposite axial directions ensure in cooperation with the two symmetrical groove tooth arrangements which convert a relative rotation into an axial displacement that the saw-tooth tooth arrangements of the first toothed disc and the second toothed disc are engaged only in the case of forward movement of the pedal cranks in order to move the running wheel forwards, and move out of engagement when the pedal cranks are stationary and when the pedal cranks move backwards so that friction and wear of the saw-tooth tooth arrangements are prevented.

There is a need for an improved free-wheel mechanism which is highly durable, and which has low wear for bicycle hubs, and which is used to transmit the drive torque in a positive-locking manner and which allows independence of the drive and output as soon as the output speed is higher than the drive speed.

The number of saw teeth is decisive for how large the idle running angle is, about which the first toothed disc has to rotate relative to the other toothed disc before the two saw-tooth tooth arrangements move into engagement with each other and a torque transmission becomes possible. It is obvious that this idle running angle should be as small as possible. On the other hand, the saw-tooth tooth arrangements must have as many saw teeth as possible. In this instance, the conflict of objectives involves the fact that the engaging face of each tooth pairing decreases, the more saw teeth become distributed over the circumference of a toothed disc, which results in a smaller transmissible torque and a decreased durability as a result of greater wear.

### SUMMARY

An improved hub is provided, in particular for bicycles, which has a free-wheel mechanism which provides an engaging face which is as large as possible with the smallest possible idle running angle in order to transmit torque, and which has low maintenance and is durable.

This is achieved by a hub having the features disclosed herein. Advantageous embodiments and developments are described and explained in detail below.

In this case, if a pairing of saw-tooth tooth arrangements, which are engaged with each other, of axially adjacent toothed discs is mentioned below, this is also intended to be understood to be a pairing of a toothed disc with a saw-tooth tooth arrangement and a perforated disc with holes, in which the saw teeth engage only in one rotation direction in a positive-locking manner and so as to transmit torque. In this variant, the saw teeth slide in the opposite rotation direction on the edges of the holes. The holes perform the same function in this regard as a second saw-tooth tooth arrangement. This variant which is expressly also intended to be included by the protective scope has the additional advantage that material and therefore weight can be saved, and less structural space is required.

In a hub, in particular for bicycles, which has an axle on which a hub member and a free-wheel member are rotatably arranged, wherein the hub member and the free-wheel member are coupled to each other by a free-wheel mechanism which is based on a pairing of saw-tooth tooth arrangements, which are engaged with each other, of axially adjacent toothed discs and which thereby forms a rotationally secure connection for one rotation direction between the free-wheel member and the hub member, at least two pairings of cooperating saw-tooth tooth arrangements are provided according to the invention.

By using two or more pairings of cooperating saw-tooth tooth arrangements, a doubling of the engagement face can immediately be achieved in comparison with the conventional use of a single pairing of cooperating saw-tooth tooth arrangements without any additional means, whereby the transmissible torque is also doubled, and the wear is minimised in an extraordinarily powerful manner.

In a simple embodiment, a plurality of pairings of saw-tooth tooth arrangements can be produced in that twice as many toothed discs are used as pairings are intended to be provided. Thus, for example, it would be possible to produce two pairings by using four toothed discs, three pairings by using six toothed discs, etc. In this case, there could further be provision for the cooperating toothed discs of a saw-tooth tooth arrangement to be rotated relative to each other with respect to the cooperating toothed discs of a saw-tooth tooth arrangement so that the saw-tooth tooth arrangements are phase-shifted relative to each other, that is to say that the teeth of a pairing are each arranged between two teeth of a different pairing. In this manner, the number of engaging locations at which a pairing of cooperating saw-tooth tooth arrangements moves into engagement over a complete revolution can be doubled, tripled, etc., in the simplest manner.

According to an advantageous embodiment, in order to simplify the constructional structure of the proposed hub there may be provision for an arrangement of three toothed discs to comprise two external toothed discs and one central toothed disc which is arranged between the external toothed discs, wherein the central toothed disc has at each of the two front sides thereof a saw-tooth tooth arrangement and each of these two saw-tooth tooth arrangements cooperates with a corresponding saw-tooth tooth arrangement of one of the two external toothed discs. In other words, the same effect as described above can be achieved with fewer toothed discs: two pairings with three toothed discs, three pairings with four toothed discs, etc.

In the above embodiment with three toothed discs, for example, there may be provision for the central toothed disc to be connected to the hub member in a rotationally secure manner and for the two external toothed discs to be connected to the free-wheel member in a rotationally secure manner. Alternatively, there may be provision for the central toothed disc to be connected to the free-wheel member in a rotationally secure manner and for the two external toothed discs to be connected to the hub member in a rotationally secure manner.

Furthermore, for example, in the above embodiment with three toothed discs there may be provision for the two saw-tooth tooth arrangements of the central toothed disc to be phase-shifted relative to each other. As a result, the effect already described above is nevertheless achieved, that the idle running angle is reduced with the engaging face remaining constant, with a reduction of the number of toothed discs used. Depending on the total number of toothed discs used and therefore the produced pairings of cooperating saw-tooth tooth arrangements, the engaging face can even be increased if the number of teeth per saw-tooth tooth arrangement is reduced so that a higher durability can be achieved. By skilfully using the phase shift, a very high number of engaging locations can nevertheless be produced so that the idle running angle is very small.

In a particular embodiment of the proposed hub, there may be provision for at least two pairings of cooperating saw-tooth tooth arrangements in opposite effective directions to form a rotationally secure connection between the free-wheel member and the hub member. In this manner, it is possible to achieve a torque transmission in both rotation directions of a relative rotation, either simultaneously or where applicable.

To this end, in a preferred embodiment of the proposed hub there may be provision for at least one toothed disc to be able to be axially displaced back and forth between two positions in order to produce the engagement of a pairing of cooperating saw-tooth tooth arrangements or to interrupt it. In other words, it is possible in the proposed hub to switch back and forth between a “forward gear” and a “reverse gear”, wherein a free-wheel function is further obtained in the other rotation direction or to completely switch off the free-wheel action so that the running wheel is driven in each rotation direction.

It may further be advantageous to provide for at least one restoring spring to act in an axial direction on at least one toothed disc. In this manner, the cooperating saw-tooth tooth arrangements of a pairing are always brought into engagement with each other again when a drive torque is applied.

It has been found to be particularly advantageous to make provision for the free-wheel member to have a portion which is located outside the hub member, and which is rotatably supported on the axle, and to have a portion which is located inside the hub member and on which the hub member is rotatably supported. There may further be provision for the toothed discs to be arranged in the region of the portion, located inside the hub member, of the free-wheel member. In this manner, the most sensitive components of the free-wheel mechanism are accommodated inside the hub member in a space-saving manner and in a state protected from contamination and damage.

In this invention, at least three toothed discs are provided for the improved free-wheel hub proposed in this instance. These discs are concentrically arranged in series on the rotation axle of the bicycle hub, wherein at least one disc is fixed to the hub member for the slip-free force transmission and at least one disc is fixed to the free-wheel member for the tangential force transmission. In order to achieve the independence of the drive and output, tooth arrangements with a saw tooth profile are provided on the parallel faces of the discs. These tooth arrangements allow, similarly to a ratchet mechanism, the positive-locking torque transmission in one rotation direction while, in the opposite rotation direction, a free movement is permitted. To this end, the toothed discs can be fixed in an axially displaceable manner relative to each other and tensioned via a spring mechanism or other tensioning mechanism. A defined number of engaging locations is produced via the tooth arrangement.

By the at least three toothed discs being arranged, at least two pairings of cooperating saw-tooth tooth arrangements which can contribute to the torque transmission are produced. A number of possible ways of influencing the force transmission between the drive and output result. Firstly, the engaging face and therefore the possible force transmission can be increased by each additional toothed disc for the same radial structural space. Furthermore, an increase of the engaging locations can be achieved with a phase-shifted arrangement of the tooth engagements, whereby the idle running angle before the first tooth engagement is reduced.

In a particularly advantageous manner, the discs can be configured in a switchable manner, whereby it becomes possible to select between permanent force transmission in both rotation directions (fixed gear) and free-wheeling in one rotation direction. In this case, the teeth are arranged at one side in the force direction and, at the other side, counter to the force direction.

### BRIEF DESCRIPTION OF THE DRAWINGS

The invention is explained below with reference to an embodiment and associated drawings, in which:

FIG. 1 shows an overall view of the hub according to one embodiment;

FIG. 2 shows an axial section through the embodiment;

FIG. 3 shows an exploded view of the hub according to the embodiment; and

FIG. 4 shows a detailed view of the components of the free-wheel mechanism of the embodiment.

### DETAILED DESCRIPTION

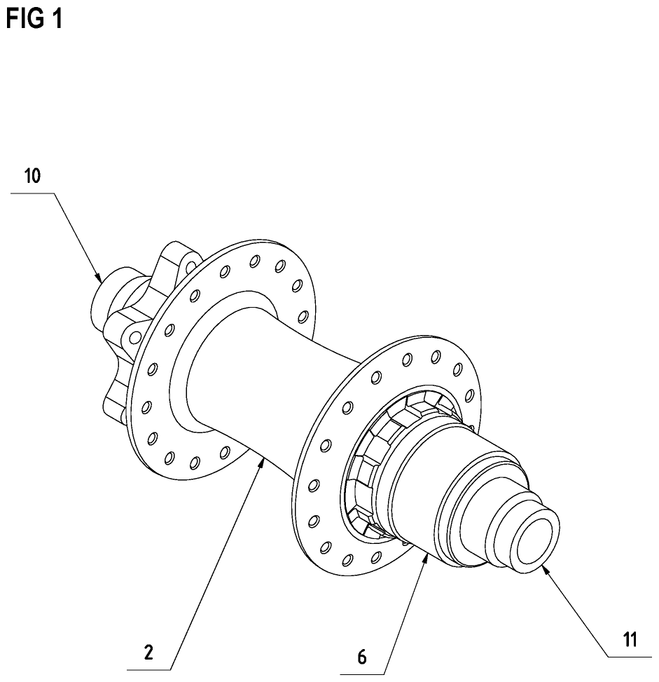

FIG. 1 shows the hub according to the invention as an overall view. It shows how the hub member 2 and the free-wheel member 6 are arranged relative to each other on the axle 1 which is closed at the drive side by the covering cap 11 and at the non-drive side by the covering cap 10.

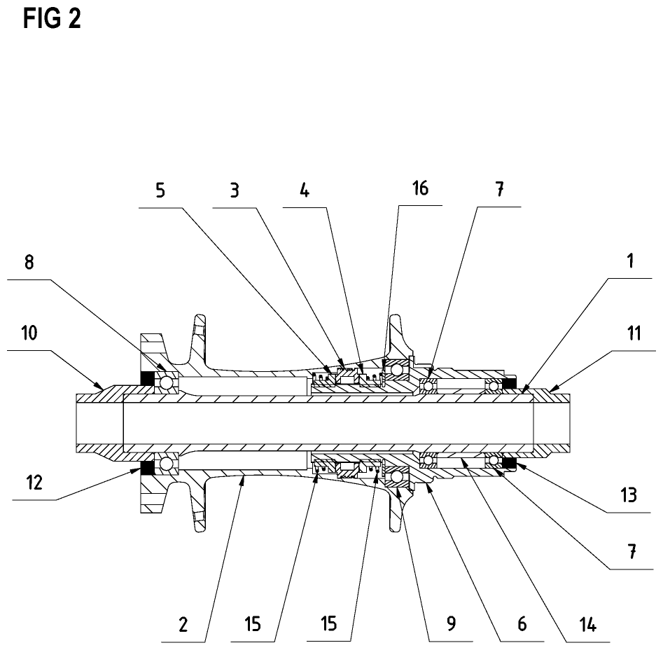

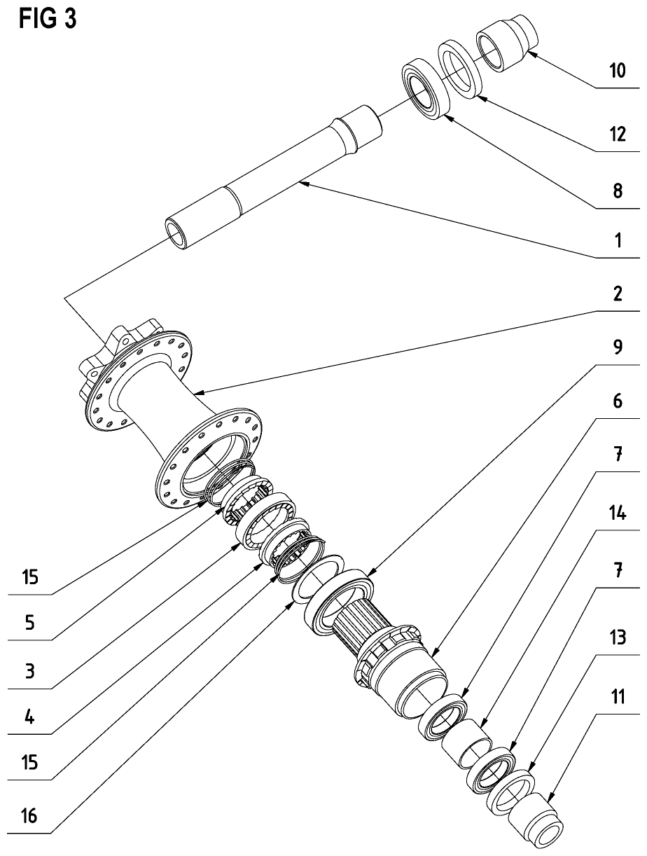

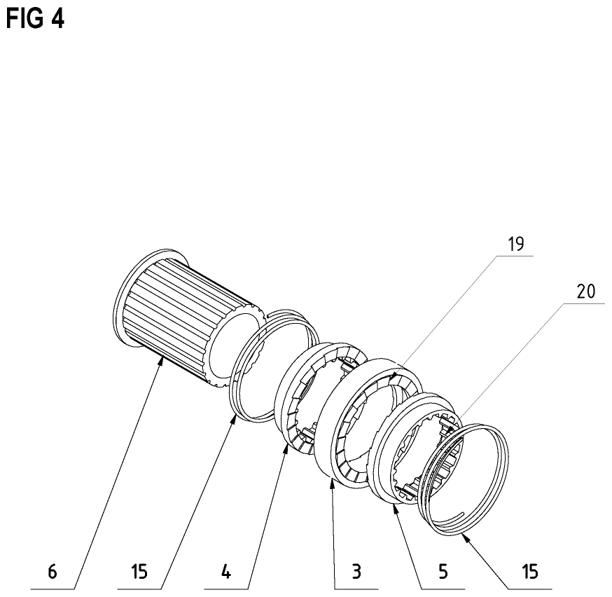

With reference to FIGS. 2, 3 and 4, it can be seen that the hub has an axle 1 on which a hub member 2 and a free-wheel member 6 are rotatably arranged.

The free-wheel member 6 has a portion which is located outside the hub member 2 and which is rotatably supported by means of two free-wheel bearings 7 on the axle 1 and a portion which is located inside the hub member 2 and on which the hub member 2 is rotatably supported by means of a hub bearing 9. At the non-drive side, the hub member 2 is rotatably supported directly on the axle 1 by means of an additional hub bearing 8.

The hub member 2 and the free-wheel member 6 are coupled to each other by a free-wheel mechanism which is based on a pairing of saw-tooth tooth arrangements, which are engaged with each other, of axially adjacent toothed discs and which thereby forms a rotationally secure connection between the free-wheel member 6 and the hub member 2 for one rotation direction. In the embodiment, two pairings 4-3, 5-3 of cooperating saw-tooth tooth arrangements are formed by three toothed discs 3, 4, 5.

The toothed discs 3, 4, 5 are arranged in the region of the portion, located inside the hub member 2, of the free-wheel member 6. The drive-side external toothed disc 4 and the non-drive-side toothed disc 5 are arranged on the portion, located inside the hub member 2, of the free-wheel member 6 and connected to the free-wheel member 6 in a rotationally secure manner. At the same time, they are axially displaceable counter to the force of a restoring spring 15 in order to bring into engagement the front saw-tooth tooth arrangements thereof where applicable with the two saw-tooth tooth arrangements of the two front sides of the central toothed disc 3 or to release them therefrom. The central toothed disc 3 is axially arranged between the drive-side external toothed disc 4 and the non-drive-side toothed disc 5 and connected to the hub member 2 in a rotationally secure manner with the external circumference thereof.

The two saw-tooth tooth arrangements of the central toothed disc 3 are phase-shifted relative to each other, that is to say, each tooth of one saw-tooth tooth arrangement is arranged between two teeth of the other saw-tooth tooth arrangement. The idle running angle which has to be overcome until the idle running engages and a torque is transmitted from the free-wheel member 6 to the hub member 2 is thereby halved. In other words, in spite of a very small idle running angle of the proposed free-wheel mechanism, each saw-tooth tooth arrangement can have a relatively large angle between the individual teeth, therefore a relatively small number of teeth and a relatively great engaging face for the other saw-tooth tooth arrangement, whereby a relatively high torque can be transmitted and relatively little wear occurs.

### LIST OF REFERENCE NUMERALS

1 Axle
2 Hub member
3 Central two-sided toothed disc
4 External toothed disc at drive side
5 External toothed disc at non-drive side
6 Free-wheel member and shaft
7 Free-wheel bearing
8 Hub bearing at non-drive side
9 Hub bearing at drive side
10 End cap at non-drive side
11 End cap at drive side
12 Seal at non-drive side
13 Seal at drive side
14 Spacer sleeve
15 Restoring spring
16 Sealing and covering cap

What is claimed is:

1. A hub comprising an axle on which a hub member and a free-wheel member are rotatably arranged, wherein the hub member and the free-wheel member are coupled to each other by a free-wheel mechanism which is based on a pairing of saw-tooth tooth arrangements, which are engaged with each other, of axially adjacent toothed discs and which thereby forms a rotationally secure connection for one rotation direction between the free-wheel member and the hub member, wherein at least two pairings of cooperating saw-tooth tooth arrangements are provided.

2. The hub according to claim 1, wherein the two saw-tooth tooth arrangements of a pairing are phase-shifted relative to each other.

3. The hub according to claim 1, wherein an arrangement of three toothed discs comprises two external toothed discs and one central toothed disc which is arranged between the external toothed discs, wherein the central toothed disc has at each of two front sides thereof a saw-tooth tooth arrangement and each of the two saw-tooth tooth arrangements cooperates with a corresponding saw-tooth tooth arrangement of one of the two external toothed discs.

4. The hub according to claim 3, wherein the central toothed disc is connected to the hub member in a rotationally secure manner and the two external toothed discs are connected to the free-wheel member in a rotationally secure manner.

5. The hub according to claim 3, wherein the central toothed disc is connected to the free-wheel member in a rotationally secure manner and the two external toothed discs are connected to the hub member in a rotationally secure manner.

6. The hub according to claim 3, wherein the two saw-tooth tooth arrangements of the central toothed disc are phase-shifted relative to each other.

7. The hub according to claim 1, wherein at least two pairings of cooperating saw-tooth tooth arrangements in opposite effective directions form a rotationally secure connection between the free-wheel member and the hub member.

8. The hub according to claim 1, wherein at least one toothed disc can be axially displaced back and forth between two positions in order to produce the engagement of a pairing of cooperating saw-tooth tooth arrangements or to interrupt it.

9. The hub according to claim 8, wherein at least one restoring spring acts in an axial direction on at least one toothed disc.

10. The hub according to claim 1, wherein the free-wheel member has a portion which is located outside the hub member and which is rotatably supported on the axle and has a portion which is located inside the hub member and on which the hub member is rotatably supported.

11. The hub according to claim 10, wherein the toothed discs are arranged in the region of the portion, located inside the hub member, of the free-wheel member.
